(19) United States
(12) Patent Application Publication
(10) Pub. No.: US 2003/0225787 A1
(43) Pub. Date: Dec. 4, 2003

(54) System and method for storing and retrieving thesaurus data

(76) Inventors: Songqiao Liu, Los Angeles, CA (US); Chenyang Song, Los Angeles, CA (US)

Correspondence Address: Marvin H. Kleinberg, KLEINBERG & LERNER, LLP, 2049 Century Park East, Suite 1080, Los Angeles, CA, 90067, US

(21) Appl. No.: 10/386,017

(22) Filed: Mar. 10, 2003

Related U.S. Application Data
(60) Provisional application No. 60/363,895, filed on Mar. 12, 2002.

(51) Int. Cl. G06F 17/00

(52) U.S. Cl. 707/104.1

(57) ABSTRACT

A method of retrieving thesaurus data stored on a computer system includes the steps of identifying the thesaurus term of interest to a user, retrieving a unique identifier associated with the term, constructing a folder path in a hierarchical folder system used to store the thesaurus data on the computer system, locating a folder containing thesaurus data associated with the unique identifier, retrieving thesaurus data associated with the unique identifier from the folder, and rendering the thesaurus data on a display device of the computer system.

### CROSS-REFERENCE TO RELATED APPLICATIONS

The present application is a continuation in part of U.S. provisional patent application serial No. 60/363,895, which is incorporated into the present application by this reference.

### BACKGROUND

1. Field of the Invention

The present application is a continuation in part of U.S. provisional patent application serial No. 60/363,895, which is incorporated into the present application by this reference.

2. Prior Art

A thesaurus is tool which can be used in fields that have a need to describe numerous and various items in a precise and exact manner. For example, a thesaurus can be used by a museum to index the objects in its collection. A thesaurus identifies terms used in a particular field or area, and defines relationships between the terms. A thesaurus does not contain all possible terms that may be used in a particular field. Instead, a thesaurus uses a controlled vocabulary, which is a limited set of relevant terms that are used in a given field.

A major purpose of a thesaurus is to match the terms brought to the system by a researcher with the terms used by an indexer. Whenever there are alternative names for a type of item, a indexer will have to choose one to use for indexing, and provide an entry under each of the others saying what the preferred term is. For example, a library thesaurus may index all full-length works of fiction as “novels”. Then, someone who searches for “mysteries” must be told that they should look for “novels” instead. This is no problem if the two words are really synonyms, and even if they do differ slightly in meaning it may still be preferable to choose one and index everything under that. The thesaurus will therefore indicate synonyms in the controlled vocabulary for terms within the thesaurus.

A thesaurus will also describe other types of relationships between words. For example, a thesaurus will often organize terms in a hierarchical format. The term “novels” in the present example, can be a subset of the term “works of fiction” (which might also include “poems” and “short stories”). Thus, the thesaurus will specify where in the hierarchy the terms in the controlled vocabulary fall. Broader terms and lesser-included terms can be specified. Other types of relationships can also be specified by the thesaurus.

The present invention does not create a thesaurus, but instead is a method of storing and retrieving data for a thesaurus which has already been created. During the process of constructing the thesaurus, each term in the thesaurus is assigned a unique identifier which is referred to as the “node number.” The unique identifier can also be referred to with 15 other, equivalent, terms such as “record number,” “file number” “sequence number” or the like. Of course, if the node number has not previously been assigned, then it is a fairly straightforward process to assign the node numbers.

### SUMMARY OF THE INVENTION

A method of retrieving thesaurus data in XML stored on a computer system includes the steps of identifying the thesaurus term of interest to a user, retrieving a unique identifier associated with the term, constructing a folder path in a hierarchical folder system used to store the thesaurus data on the computer system, locating a folder containing thesaurus data associated with the unique identifier, retrieving thesaurus data associated with the unique identifier from the folder, and rendering the thesaurus data on a display device of the computer system. The thesaurus data is stored by a reverse process.

### BRIEF DESCRIPTION OF THE DRAWINGS

FIG. 1 is a block diagram showing a general purpose computer system which can implement the method of the present invention.

FIG. 2 illustrates the major steps of the method of retrieving thesaurus data used in the present invention.

FIG. 3 illustrates a window in a graphical user interface used in the method of the present invention.

FIG. 4 illustrates a folder file structure for a thesaurus.

FIG. 5 illustrates the organization of sub folders used to store data relating to thesaurus terms.

FIG. 6 illustrates XML files containing term data stored in a particular sub folder.

FIG. 7 illustrates the major steps of the method of storing thesaurus data used in the present invention.

FIG. 8 illustrates a folder structure for data elements used in keyword searching of the thesaurus.

### DETAILED DESCRIPTION OF THE INVENTION

A system and method of storing and retrieving thesaurus data will be described. In the following description, specific method steps and procedures are described in order to give a more thorough understanding of the present invention. In other instances, well known elements such as the operating system and specific software functions are not described in detail so as not to obscure the present invention unnecessarily.

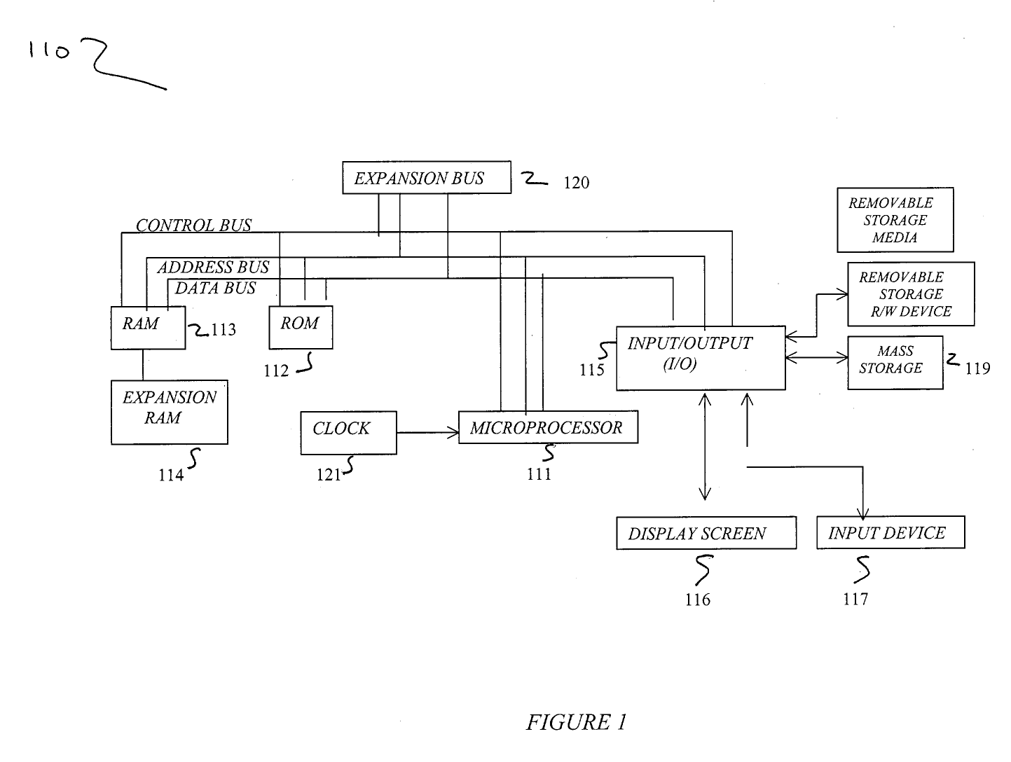

Referring first to FIG. 1, a block diagram of a general purpose computer system which can be used to implement the method of the present invention is illustrated. Specifically, FIG. 1 shows a general purpose computer system 150 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The thesaurus data which is stored in the present invention will be generally stored on mass storage device 119.

In operation, information is input into the computer system 110 by typing on a keyboard, manipulating a mouse or trackball, or “writing” on a tablet or on position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system or Web server. Various other types of computers, however, may be used depending upon the size and complexity of the required tasks. Suitable computers include mainframe computers, multiprocessor computers and workstations. Typically, the program of the present invention will be stored on mass storage device 119 until a user of the computer system 111 initiates its operation. Portions of the program may then be transferred to RAM 113 while the program executes. Alternatively, the program of the present invention may reside in RAM 113 or ROM 112.

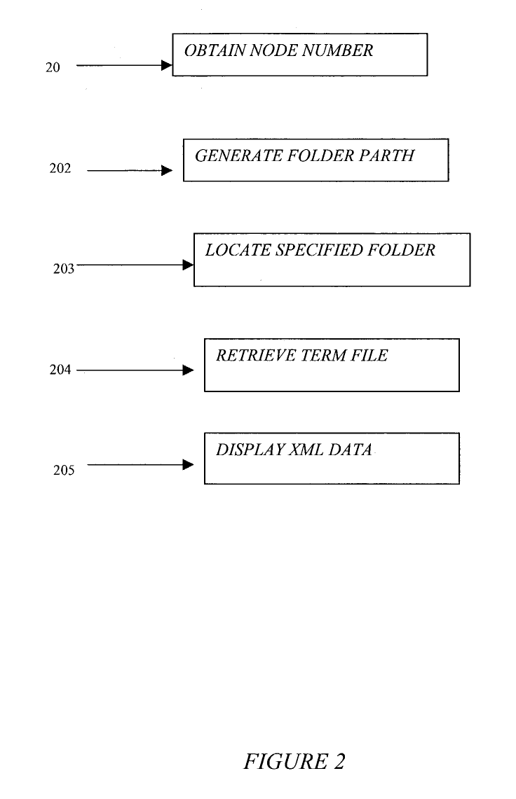

The present invention incorporates a method of storing and retrieving thesaurus-related data in XML which can be implemented on the general-purpose computer system described in FIG. 1. Referring next to FIG. 2, the main steps in the method of retrieving information regarding a term in the thesaurus is shown. As discussed above, each term in the thesaurus is assigned a unique identifier, which in the present invention is described as a node number. In step 200, the user first obtains the node number corresponding to the term which is sought.

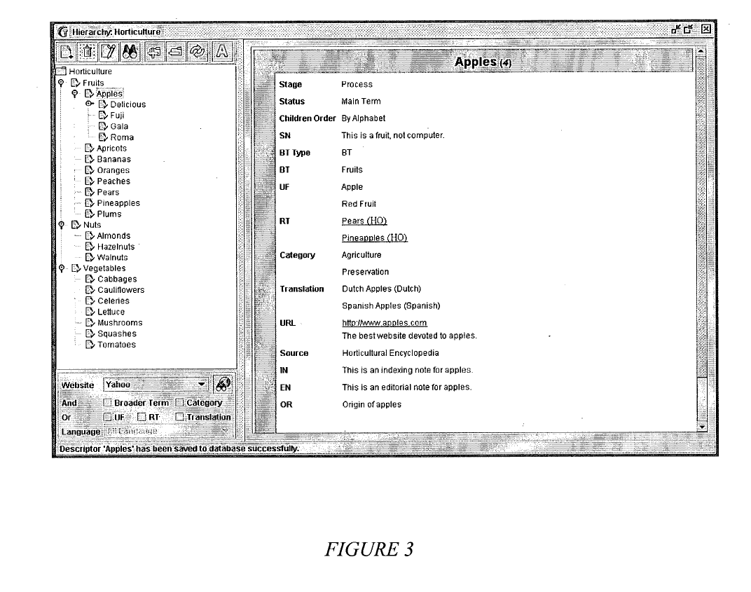

The preferred embodiment of the present invention utilizes the hierarchical folder structure that is implemented in graphical user interface (GUI) of the Windows, Unix and other well-known computer operating systems. The folder structure is used in assisting the user in obtaining the node number. FIG. 3 illustrates a screen display which is generated by a computer system which is utilizing the method of the present invention.

In FIG. 3, there is shown a window 120 of a GUI with two display areas 121 and 122. Display area 122 displays the information regarding the thesaurus term which has been retrieved using the method of the present invention. Display area 121 contains all of the terms of the thesaurus which is being used. In the usual case, the elements of the thesaurus will be organized in a hierarchical structure. Thus, FIG. 3 shows the thesaurus terms displayed in the same hierarchical manner in display area 120. The thesaurus terms are not limited to being displayed in the hierarchical format. In an alternative format, the thesaurus terms are organized alphabetically. Other arrangements can be used with equal effectiveness, such as string length or chronologically (e.g., by date of creation).

The user selects the thesaurus term of interest by highlighting the term using standard navigation techniques of the GUI. For example, the user can use a point and click device, such as a mouse or trackball. Equivalently, the user can employ keyboard commands to highlight the selected term. In FIG. 3, the selected term 124 is “apples” which is a term in the thesaurus.

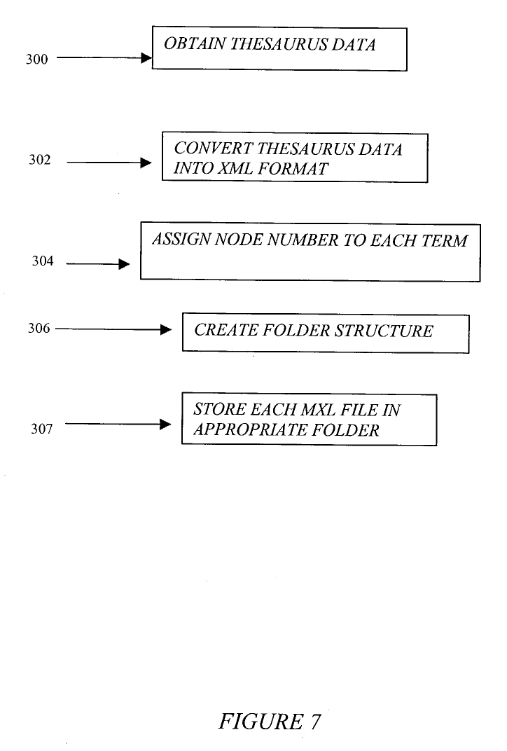

Once the term of interest has been selected, the computer system will retrieve the node number associated with the term. The node number is stored in a look-up table associated with the folder tree. In the present example the term “pastoral” will be assigned the node number 161. (It will be apparent to those of skill in the art that the example given is arbitrary, and that any given node number will work with equal effectiveness. The actual node number will be assigned when the thesaurus is constructed, as described with reference to FIG. 7 below.) After the node number is retrieved, the system moves to step 201 in FIG. 2, which is to generate the folder path for the particular thesaurus term selected.

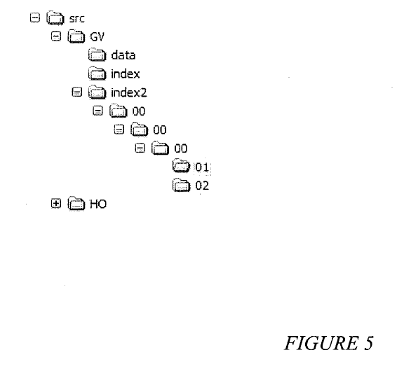

Referring next to FIG. 5, there is shown a folder and data arrangement for a typical thesaurus of the present invention. The folders GV (131), HO (135), TG (136) and UL (137) all contain separate thesauri (i.e., there can be more than one thesaurus on any give computer system.) Nested under each thesaurus folder are three folders 132, 133 and 134. In the preferred embodiment, these folders are labeled data, index and index2, respectively. The names given to these folders are arbitrary, and are chosen as an aid to the user. The folder index2 contains a subfolder tree in which all of the data for the thesaurus is ultimately stored. Step 102 generates the path for the particular folder which stores the data for the selected node number—in this case 161.

The path is generated by padding leading zeros to the node number to form a ten digit string. Thus, node number 161 becomes 0000000161. The use of ten digits results in a data structure which allows for the storage of a large number of terms for the thesaurus. This string is then divided evenly into five parts with two digits each. The first four parts are used as folder names and the last part is used as the file name for the actual data for the node. Thus, in the present example, the file for node number 161 is located at GV/index2/00/00/00/01/61.XML.

The structure serves multiple purposes. One is to make sure that there will not be a large number of data files for the thesaurus terms under any particular folder. Limiting the number of files in a given folder decreases access time. Another reason is that the access path can be easily created when information regarding a particular thesaurus term needs to be retrieved.

The preferred embodiment of the present invention utilizes a ten-digit string for the node number. This number was chosen because it permits the storage and retrieval of up to one hundred million different thesaurus terms. This is an extremely large number of terms, and is greater than all thesauri in use at the present time. It will be apparent to those of skill that a larger or small string for the node number can be used with equal effectiveness. For example, if only a relatively small number of terms are in a given thesaurus, then the string size can be reduced without departing from the present invention. In an alternative embodiment, a string size of six digits will permit the storage and retrieval of up to one hundred thousand thesaurus terms.

The preferred embodiment of the present invention also uses zeros to pad any string spaces which are not in the node number. The use of leading zeros is arbitrary, and is used for purposes of convenience and ease of recognition. It will be apparent to those of skill in the art that a different character can be used with equal effectiveness.

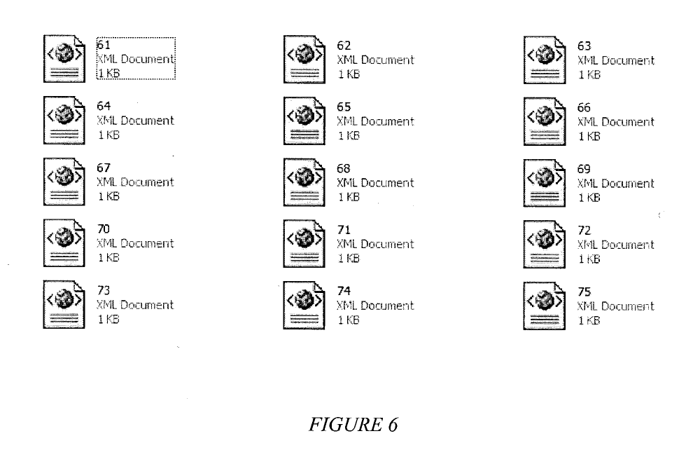

Referring again to FIG. 2, the next step 203 in the method is to locate the specified folder containing data for the thesaurus term. FIGS. 5 and 6 illustrate the manner in which the data is stored. FIG. 5 shows the folder structure for the path GV/index2/00/00/00/01/61.XML. The computer system locates folder 01 (138) in step 203. The preferred embodiment of the present invention stores the data for each term as an XML file. It has been found that XML files are the most advantageous format for retrieving and rendering the data. The use of an XML format allows the present invention to avoid the use of a commercial database management system, such as those sold by Oracle. Such a database can be costly, and requires significant support. The use of XML files to store data makes the method of the present invention easy to deploy. The files may be compressed to reduce storage space and decrease transmission time. With the structure of the preferred embodiment, up to ten data files are stored in each sub folder. This is illustrated in FIG. 6.

After the appropriate folder storing the term data is located, the desired XML file is retrieved in step 204. The XML data format allows the information to be easily rendered for display in step 205. The XML file format is used in the preferred embodiment, because it can be used by different operating systems and different computer platforms without changing the data structure. It will be apparent to those of skill in the art that different types of file formats can be used if desired. The present invention is not limited to storing and retrieving thesaurus data in XML format.

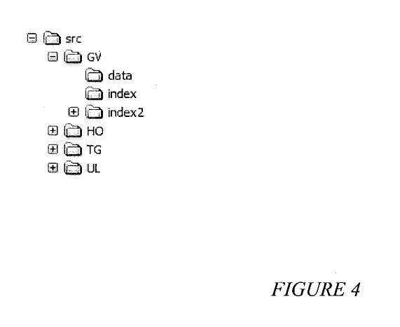

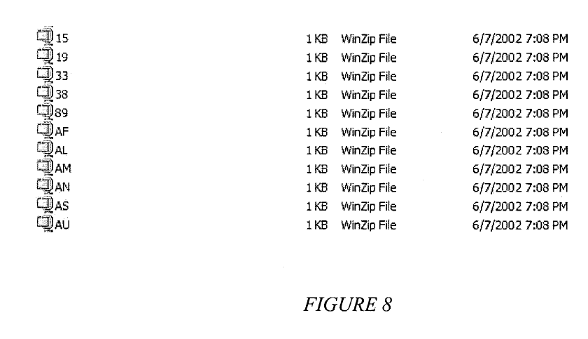

The present invention provides an alternative method of obtaining the node number for a given thesaurus term. Referring again to FIG. 4, the folder “index” contains inverted files for keyword searching. All of the terms in the controlled vocabulary of the thesaurus are sorted according to the first two characters of the term being used as a descriptor. The terms are stored in the “index” folder with descriptors starting with the same first two characters being stored in the same file. A sample collection of folders with the two letter descriptors are illustrated in FIG. 8. A user can then perform a keyword search for terms in the controlled vocabulary. The thesaurus term which is retrieved in the keyword search is located in the folders of FIG. 8, and the user can select the desired thesaurus, which will be associated with the corresponding node number.

The method of storing the thesaurus data in XML will now be described. Referring next to FIG. 7, the first step 300 in storing the thesaurus data is to obtain the thesaurus. Next, in a converting step 302, the data relating to each thesaurus term is then converted to XML format. This conversion can be accomplished in manner which is well-known in the prior art. The node number for each term is then assigned in step 304. The folder structure is created in step 306. The folders are creating and organized as described above with respect to FIG. 5. Once all of the folders have been created, the XML files are stored in the corresponding folders using the last two digits of the node number as the file name. After the data is stored, it can be retrieved-utilizing the method described above.

It will be apparent to those of skill in the art that the steps in the foregoing method do not need to be performed in the exact order in which they have been described. The order may be varied without departing from the overall scope of the present invention. For example, the steps illustrated in FIG. 7 can each be performed for a single thesaurus term before the next term is stored. Alternatively, the computer system can perform each step illustrated in FIG. 7 on all of the thesaurus terms before proceeding to the next step. In addition, the step of creating the folder tree can be performed before all of the other steps, even before the thesaurus data is obtained. All that is required is that each of the steps be performed in connection with each thesaurus term.

Accordingly, a system and method of storing and retrieving thesaurus data has been described. It is to be understood that the foregoing description has been made with respect to specific embodiments thereof for illustrative purposes only. The overall scope of the present invention is limited only by the following claims.

What is claimed is:

1. A method of retrieving thesaurus data in XML stored on a computer system, comprising the steps of:
(a) identifying the thesaurus term of interest to a user;
(b) retrieving a unique identifier associated with said term;
(c) constructing a folder path in a hierarchical folder system used to store the thesaurus data on the computer system;
(d) locating a folder containing thesaurus data associated with said unique identifier;
(e) retrieving thesaurus data associated with said unique identifier from said folder;
(f) rendering the thesaurus data on a display device of the computer system.

2. The method of claim 1 wherein said identifying step is accomplished using a graphical user interface on a computer system wherein thesaurus terms are displayed.

3. The method of claim 2 wherein said thesaurus terms are displayed in a hierarchical format.

4. The method of claim 2 wherein said thesaurus terms are displayed in an alphabetical format.

5. The method of claim 1 wherein said unique identifier comprises a node number.

6. The method of claim 1 wherein said unique identifier comprises a record number.

7. The method of claim 1 wherein said step of constructing said folder path comprises the steps of:
(a) converting said node number into a string of fixed length by padding said node number with leading zeros, and
(b) dividing said string into a fixed number of parts of two digits each, wherein each of said two digits comprises a sub-folder name.

8. The method of claim 1 wherein said thesaurus data comprises an XML file.
